(19) United States
(12) Patent Application Publication
(10) Pub. No.: US 2010/0046246 A1
(43) Pub. Date: Feb. 25, 2010

(54) ILLUMINATING TEXTILE WEB, CONVERSION PROCESS, AND LUMINOUS DEVICE COMPRISING A PLURALITY OF ILLUMINATING REGIONS

(76) Inventors: Eric Bihr, Meys (FR); Flavien Bergonnier, Souzy (FR)

Correspondence Address: MARJAMA MULDOON BLASIAK & SULLIVAN LLP, 250 SOUTH CLINTON STREET, SUITE 300, SYRACUSE, NY, 13202, US

(21) Appl. No.: 12/441,013

(22) PCT Filed: Sep. 18, 2007
(86) PCT No.: PCT/FR07/51965

§ 371 Date: Mar. 12, 2009

(30) Foreign Application Priority Data
Sep. 19, 2006 (FR) 0653824

(51) Int. Cl. D03D 15/00; G02B 6/04

(52) U.S. Cl. 362/556; 362/554

(57) ABSTRACT

A textile web for producing a luminous device includes a plurality of contiguous illuminating regions that can be selectively turned on or turned off. The-web incorporates adjacent optical fibres designed to emit, laterally, the light that passes through them. Each optical fibre is, over its length and from one illuminating region to another, alternately woven and then not woven with binding yarns, the alternation of the weaving and the non-weaving of the optical fibres with the binding yarns being reversed between two adjacent groups of at least one optical fibre, so as to define, for each illuminating region, a top side including an illuminating web of optical fibres woven with the binding yarns and a reverse face including a float of optical fibres that are offset in a plane approximately parallel to the illuminating web.

### CROSS REFERENCE TO RELATED APPLICATIONS

This application is a National Stage filing under 35 U.S. C. §371 of PCT Application No. PCT/FR2007/051965, filed Sep. 18, 2007. This application also claims the benefit of French Application No. 0653824, filed Sep. 19, 2006. The entirety of both applications is incorporated herein by reference.

### FIELD OF THE INVENTION

The invention relates to the field of display panels comprising a backlighting device. It relates more particularly to devices comprising a textile web in which optical fibres are woven and are suitable for emitting light laterally towards an advertising medium to be backlit. Thus, such textile webs are generally arranged to be parallel to the advertising medium.

### BACKGROUND OF THE INVENTION

In general, luminous devices equipped with optical fibres and serving to backlight an advertising medium, may comprise a plurality of point sources arranged on the border of a textile web in which optical fibres are woven. The optical fibres are then grouped into bundles at each of their ends, and then positioned facing a point light source. Thus, such a luminous device comprises a plurality of point sources at the border of the textile web serving, if necessary, to independently illuminate the bands of optical fibres on the illuminating surface of the textile web.

However, such a type of luminous device is not suitable for independently illuminating an area located inside the textile web, without also illuminating the contiguous areas of the strip to which it belongs.

One object of the invention is to provide for a selective illumination of an advertising medium by means of luminous devices comprising a textile web in which optical fibres allow a matrix illumination of the advertising medium.

In the rest of the description, and for a better understanding of the invention, the term “matrix illumination” is used to designate a luminous device comprising a plurality of contiguous illuminating regions which can be selectively turned on or turned off.

### SUMMARY OF THE INVENTION

The invention therefore relates to a textile web, its method of conversion, and a luminous device for producing a matrix illumination of an advertising medium.

Such a textile web incorporates adjacent optical fibres suitable for laterally emitting the light that passes through them.

According to the invention, the textile web is characterized in that each optical fibre is, over its length and from one illuminating region to another, alternately woven and then not woven with binding yarns, the alternation of the weaving and non-weaving of the optical fibres with the binding yarns being reversed between two adjacent groups of at least one optical fibre, so as to define, for each illuminating region, a top side comprising an illuminating web of optical fibres woven with the binding yarns and a reverse face comprising a float of optical fibres that are offset in a plane approximately parallel to the illuminating web.

In other words, the textile web, on its top side, comprises optical fibres which may be woven locally with the binding yarns forming the armature of the textile web. The reverse face of this textile web has floats of optical fibres arranged between the two limits defining an illuminating region in a given direction. An arrangement of contiguous illuminating regions in the form of substantially square or rectangular boxes, can be produced. This arrangement of the textile web accordingly serves to provide a matrix illumination in which each illuminating region can be selectively turned on or turned off by means of the optical fibres with lateral illumination.

Such a textile web can be converted by a method in which, on the reverse face of the textile fibre, each float of optical fibres is cut and the cut optical fibres are then grouped in order to form a bundle of which a first free end is suitable for being arranged facing a point light source.

In other words, the reverse face of the textile web serves to obtain the positioning of each of the portions of optical fibres passing through each illuminating region facing a point light source. In fact, by cutting a float of optical fibres below a given illuminating region, it is possible to illuminate an adjacent illuminating region. A grouping ring may be used to join the various cut optical fibres together, but also to improve the efficiency of the light transmission inside the optical fibres by illuminating the empty spaces between each optical fibre.

Furthermore, the invention also relates to the luminous device comprising a plurality of contiguous illuminating regions that can be selectively turned on or turned off. Such a device comprises at least one web incorporating adjacent optical fibres suitable for laterally emitting the light passing through them on the side of a top side of an illuminating region.

According to the invention, the device is characterized in that each illuminating region comprises a plurality of woven optical fibres grouped in the form of a bundle of which a first free end is arranged facing a point light source located on the side of a reverse face of an illuminating region.

Thus, the device may comprise a plurality of illuminating regions formed by optical fibres which extend outside each illuminating region to be grouped and positioned facing a point source. All the point sources are arranged on the same side of the textile web facing its reverse face.

In a particular embodiment, an illuminating region may comprise a plurality of bundles of optical fibres each arranged facing a point source.

In fact, such point sources may be of the white or three-colour light emitting diode type, but also light emitting diodes of the “organic” type, also called O-LED, or even laser diodes. Moreover, three diodes of different colours may in particular be connected with three bundles belonging to the same illuminating region in order to adapt the backlighting colour according to the advertising message, for example.

Thus, such a device may be produced in various ways, and particularly using a textile web of which the reverse face comprises a plurality of floats of optical fibres. It may also comprise a plurality of textile webs arranged in the form of bands and comprising a plurality of contiguous illuminating regions. The bands are then arranged parallel to and alongside one another in order to define a matrix illuminating surface.

According to a particular embodiment, the luminous device may comprise a textile web converted by the method consisting, on the reverse face of the textile web, in cutting each float of optical fibres and then grouping the cut optical fibres in order to form a bundle of which a first free end is suitable for being arranged facing a point light source.

In other words, in this case, the device comprises a textile web capable by itself of providing the matrix illumination of the luminous device. In fact, bundles are created by cutting the floats of optical fibres and they are connected with the point light sources. The bundles are then prolonged in the illuminating regions corresponding to the woven portion of the optical fibres with the binding yarns.

Advantageously, a second free end of the bundle may be obstructed by a mask comprising a reflecting surface.

In fact, in this way, the light energy reflected by the mask participates in the lateral illumination of the optical fibre. Such a mask may in particular be in the form of an opaque object or more simply, a film having a reflecting surface.

In practice, the luminous device may comprise at least one rigid support comprising a plurality of orifices suitable for allowing the passage of the first free end of each bundle.

In other words, the rigid support acts as an opaque separating wall between, on the one hand, the textile web, and on the other hand, the illuminating region of the bundles of optical fibres by means of the point sources.

According to a particular embodiment, the rigid support may act as an equipotential terminal connected electrically to each of the point light sources.

Thus, at each orifice, a pin can be arranged for connecting a point source of which one of the terminals is connected to the rigid support. Furthermore, the rigid support comprises a sufficient electrical conductivity for limiting the losses by Joule effect.

Advantageously, the textile web may be in planar contact with the rigid support. In other words, the rigid support may serve to define a surface suitable for immobilising the textile web in at least one direction.

According to a particular embodiment, the reflecting surface may be arranged directly on the rigid support. In this case, the rigid support may comprise a reflecting surface arranged facing the textile web.

Advantageously, a reflecting mask may be inserted locally between the rigid support and the textile web.

In other words, the textile mask serves to prevent the viewing, across an illuminating region, of the bundle of optical fibres extending below and serving to illuminate a neighbouring illuminating region. Moreover, the reflecting surface of the mask, in the same way as the reflecting surface of the rigid support, serves to improve the overall illuminating efficiency of the luminous device.

Such a mask may be in the form of a band, so as to mask, along the same direction, a plurality of bundles of optical fibres belonging to contiguous illuminating regions.

According to a particular embodiment, the luminous device may comprise a transparent or translucent protective screen added on facing the textile web.

Such a protective screen thus serves to define a thickness and materializes a distance between, on the one hand, the textile web, and on the other hand, an advertising medium in particular. Such a protective screen may have various presentations and in particular the form of a solid and rigid plate. It may also be in the form of a substantially rigid plate provided with projections for defining the distance and thereby optimising the ratio between the weight of the material used and the distance to be materialized.

According to a particular embodiment, the luminous device may comprise a control unit in order to control this selective illumination and various illuminating regions of the device.

Thus, the luminous device is self-sufficient and can be arranged in particular in a public place without requiring the connection of ancillary data processing equipment for its operation.

In practice, the control unit may be suitable for storing one or more illuminating sequences.

In fact, and particularly for display panels for displaying several campaigns by means of motorized rollers, a plurality of illuminating sequences can be used. It is thus useful to be able to store the various sequences in the control unit. Moreover, an interface card with a memory card reader can be arranged at the periphery of the luminous device in order to enable an operator to transfer the data pertaining to a sequence in the control unit.

Other ancillary and optional devices may be used and connected to the control unit, such as light detectors, in order to adapt the illumination according to the external luminosity of the site in which the luminous device is placed. A presence detector may also be connected to the control unit in order, for example, to launch an illuminating sequence when a person is detected in the field of view of the device.

### BRIEF DESCRIPTION OF THE DRAWINGS

The way in which the invention is implemented and the advantages thereof will appear more clearly from the description that follows, provided for information and non-limiting, in conjunction with the appended figures in which:

FIG. 1 shows a perspective view of the top side of a textile web according to the invention;

FIG. 2 shows a cross section of a textile web;

FIG. 3 is a view of the reverse face of textile web after a conversion operation;

FIGS. 4 and 5 show cross sections according to two alternatives of an illuminating device, according to the invention.

### DETAILED DESCRIPTION OF THE INVENTION

As already stated, the invention relates to a textile web, a method for converting this web and an illuminating device formed from this textile web.

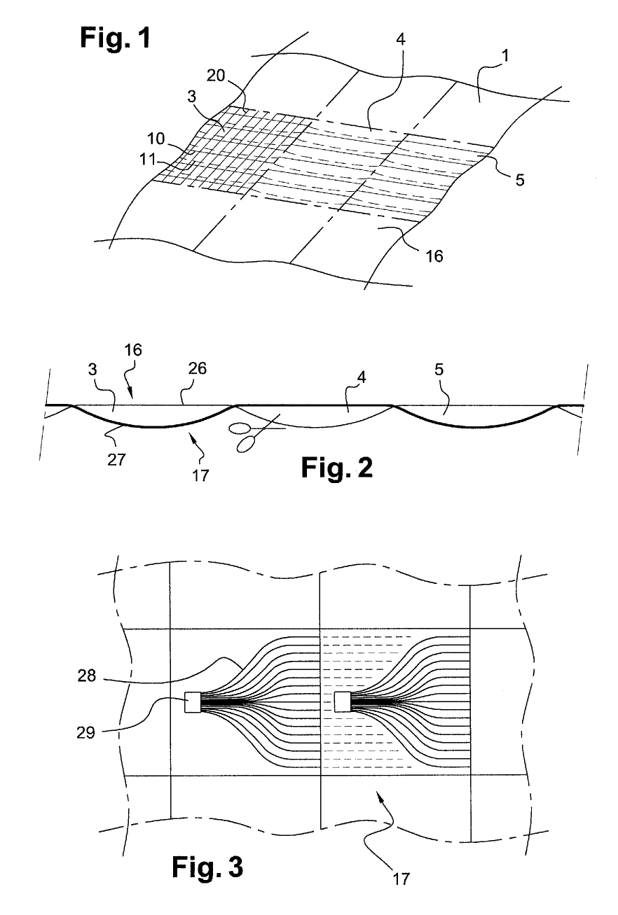

As shown in FIG. 1, the textile web (1) comprises a plurality of contiguous illuminating regions (3, 4, 5). The illumination of these zones is obtained by means of optical fibres (10, 11) woven with binding yarns (20). Each optical fibre (10, 11) is, from one illuminating region to another, woven and then non-woven with the binding yarns (20). When the optical fibres (10, 11) are woven, they appear on the top side (16) of the textile web (1). Moreover, when these optical fibres are not woven, they generate floats of optical fibres on the reverse face of the web (1), that are offset in a plane substantially parallel to the textile web (1). As shown, the alternation of the weaving and non-weaving of the optical fibres with the binding yarns is reversed between two adjacent optical fibres. However, the alternation of the weaving may also be reversed between two adjacent groups of several optical fibres.

As shown in FIG. 2, each optical fibre passes alternately from the top side (16) to the reverse face (17) generating an illuminating web (26) on the top side (16) and a float of optical fibres (27) on the reverse face (17).

As shown, the floats of optical fibres may be cut by means of a cutting tool, or even manually using a pair of scissors.

As shown in FIG. 3, the optical fibres may be grouped on the reverse face (17) in the form of a bundle (28) of which one free end (29) is placed facing a point source.

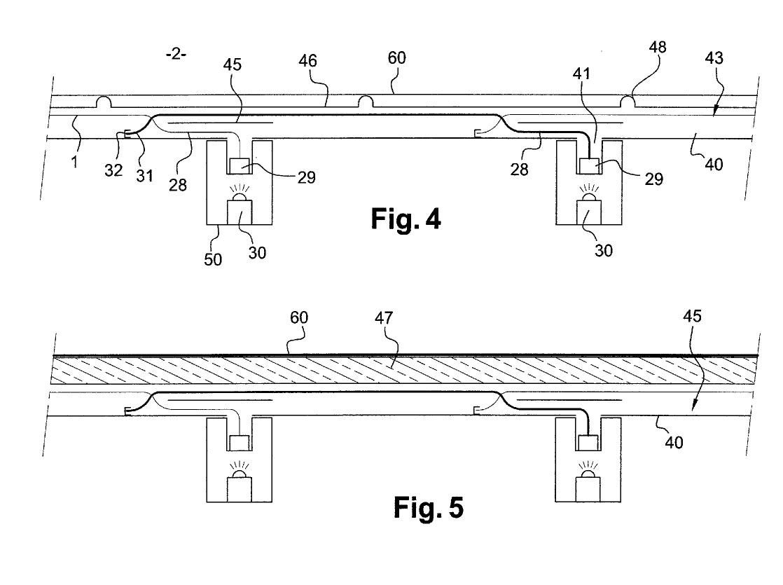

FIG. 4 shows a luminous device for backlighting an advertising message arranged on a poster (60).

According to a first alternative, the textile web (1) may be offset parallel to a rigid support (40). Moreover, the textile web (1) may also be maintained in a position substantially parallel to the poster (60) by means of a textile web as previously described.

Furthermore, the rigid support (40) comprises a plurality of orifices (41) for introducing a first free end (29) of a bundle of optical fibres (28). In this way, the free end (29) is arranged facing a point source (30) arranged in a profiled section (50). The portion of the bundle (28) extending below an illuminating region may be masked by means of a reflecting mask (45) extending substantially parallel to the textile web (1) and having the form of a band.

Furthermore, a mask (32) comprising a reflecting surface may be arranged at a second free end (31) of the bundle of optical fibres (28). In this way, it is possible to improve the illuminating efficiency in each illuminating region. A reflecting surface (43) also serves to reflect the light towards the poster to be backlit and thereby to improve the overall efficiency of the luminous device (2).

A protective screen (46) serves to protect the textile web (1) but also to define, by means of projections (48), a distance between, on the one hand, the textile web (1) and, on the other hand, the poster (60) to be backlit. Such a protective screen (46) may in particular be obtained by thermoforming a transparent plastic sheet.

According to a second alternative, and as shown in FIG. 5, the textile web (1) may be directly in contact with the rigid support (40). In this case, the rigid support (40) may have a reflecting surface (45) suitable for reflecting the light towards the poster (60).

Furthermore, the protective screen (47) may be in the form of a rigid plate serving to define the distance required between the textile web (1) and the poster (60) to guarantee properly uniform illumination.

It appears from the above that a luminous device according to the invention has many advantages, and serves in particular to obtain a selective and animated illumination of a poster to be backlit; it has a very low thickness and a very low weight; its electric power consumption is very low; it can be used to backlight non-planar posters; it is easily transportable because it can be packaged in the form of cassettes that can advantageously replace existing luminous devices.

1. A textile web for producing a luminous device comprising a plurality of contiguous illuminating regions that can be selectively turned on or turned off, the web incorporating adjacent optical fibres designed to emit, laterally, the light that passes through them, each optical fibre being, over its length and from one illuminating region to another, alternately woven and then not woven with binding yarns, the alternation of the weaving and the non-weaving of the optical fibres with the binding yarns being reversed between two adjacent groups of at least one optical fibre, so as to define, for each illuminating region, a top side comprising an illuminating web of optical fibres woven with the binding yarns and a reverse face comprising a float of optical fibres that are offset in a plane approximately parallel to the illuminating web.

2. A method for converting a textile web for producing a luminous device, the method comprising:
providing the textile web, the web comprising a plurality of contiguous illuminating regions that can be selectively turned on or turned off, and adjacent optical fibres designed to emit, laterally, the light that passes through them, each optical fibre being, over its length and from one illuminating region to another, alternately woven and then not woven with binding yarns, the alternation of the weaving and the non-weaving of the optical fibres with the binding yarns being reversed between two adjacent groups of at least one optical fibre, so as to define, for each illuminating region, a top side comprising an illuminating web of optical fibres woven with the binding yarns and a reverse face comprising a float of optical fibres that are offset in a plane approximately parallel to the illuminating web;
cutting each float of optical fibres, on the reverse face of the textile web; and
grouping the cut optical fibres to form a bundle of which a first free end is suitable for being arranged facing a point light source.

3. A luminous device comprising a plurality of contiguous illuminating regions that can be selectively turned on or turned off, the device comprising at least one textile web incorporating adjacent optical fibres designed to emit, laterally, the light that passes through them on a top side of an illuminating region, wherein each illuminating region comprises a plurality of woven optical fibres grouped in the form of a bundle of which a first free end is arranged facing a point light source located on a side of a reverse face of an illuminating region.

4. (canceled)

5. The luminous device according to claim 3, wherein a second free end of the bundle is obstructed by a mask comprising a reflecting surface.

6. The luminous device according to claim 3 further comprising at least one rigid support comprising a plurality of orifices suitable for allowing the passage of the first free end of each bundle.

7. The luminous device according to claim 6, wherein the rigid support acts as an equipotential terminal connected electrically to each of the point light sources.

8. The luminous device according to claim 6, wherein the textile web is in planar contact with the rigid support.

9. The luminous device according to claim 6, wherein the rigid support comprises a reflecting surface arranged facing the textile web.

10. The luminous device according to claim 6, wherein a reflecting mask is inserted locally between the rigid support and the textile web.

11. The luminous device according to claim 3 further comprising a transparent or translucent protective screen added on facing the textile web.

12. The luminous device according to claim 3 further comprising a control unit for controlling the selective illumination of the various illuminating regions of the device.

13. The luminous device according to claim 12, wherein the control unit is suitable for storing one or more illuminating sequences.
